(19) United States
(12) Patent Application Publication
(10) Pub. No.: US 2009/0008466 A1
(43) Pub. Date: Jan. 8, 2009

(54) Heating Device Using a Calorimetric Measurement Flow Sensor for Overheating Protection

(75) Inventors: Hans-Michael Wardenga, Neddemin (DE); Dino Horning, Neuendorf (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Webasto AG, Stockdorf (DE)

(21) Appl. No.: 11/577,294

(22) PCT Filed: Oct. 11, 2005
(86) PCT No.: PCT/DE05/01821

§ 371 Date: Mar. 6, 2008

(30) Foreign Application Priority Data
Oct. 13, 2004 (DE) 10 2004 049 904.7
Mar. 3, 2005 (DE) 10 2005 009 786.3

(51) Int. Cl. B60H 1/00; G01K 17/00

(52) U.S. Cl. 237/28; 374/31

(57) ABSTRACT

A heater (10), especially a motor vehicle heater (10), which has device for determining the temperature and/or which works as overheating protection. It is provided that the device for determining the temperature and/or the work as overheating protection has a flow sensor (12) which works according to the calorimetric measurement principle. Furthermore, the flow sensor (12) which works according to the calorimetric measurement principle is used as a temperature sensor for determining the temperature and/or for making available overheating protection.

### BACKGROUND OF THE INVENTION

1. Field of the Invention

This invention relates to a heater, especially a motor vehicle heater which has means which work with means for determining the temperature and/or as overheating protection. Furthermore, the invention relates to a new possible application for a flow sensor which works according to the calorimetric measurement principle.

2. Description of Related Art

For example, in motor vehicle heaters which are used as auxiliary and/or independent vehicle heaters, system safety must be ensured by an overheating protection system. This applies especially when it is a heater in which a liquid heat transfer medium is heated in order to be able to release heat at the desired location. Moreover, knowledge of the current temperature of the heat transfer medium for controlling the heater is important.

In the prior art, generally, at least two sensors are used for prevention of overheating and for measuring temperature. For example, implementing overheating protection by a PTC, a bimetallic switch or a fusible insert is known. To determine the temperature, generally, a temperature-dependent resistor (NTC) is used.

Moreover, using the evaluation of temperature gradients as additional safety criteria is known. In this connection, it is assumed that an unusually strong temperature increase results from a hardware or system failure.

However, the use of the aforementioned known temperature sensors as overheating protection or for measuring the temperature is associated with some disadvantages. For example, the reliability of bimetallic switches is very high, but software-diagnosis of the state of feed lines with respect to operation, short circuit or interruption is not possible. Including the required feed lines, fastening elements, plug connectors, etc., the bimetallic switch is a relatively expensive component. Furthermore, the contact of the bimetallic switch with the heat transfer medium has a great effect on operation. This thermal contact, which is important for correct operation of the bimetallic switch, cannot be reliably ensured in many cases over the service life of the heater because problems can occur with respect to the safety of installation, corrosion and deposits in the heat exchanger.

A reaction to a dangerous state takes place in the known designs only after reaching the component-specific operating temperature. This also applies to use of a PTC or a fusible link as overheating protection. A fuse-link also has the disadvantage that it is destroyed by triggering and must be replaced.

The evaluation of temperature gradients has the disadvantage that this principle fails especially in so-called dry overheating which occurs, for example, when there is too little or no coolant, e.g., cooling water, in the system. This failure is due to the fact that the cooling medium which is present in this case (for example, air or water vapor), due to lower heat capacity and lower thermal conductivity, leads to the temperature sensor detecting the overheating on a delayed basis; this can lead to damage to the heater.

### SUMMARY OF THE INVENTION

The object of the invention is to develop the generic heaters such that the above explained problems are avoided, and at the same time, the possible uses of known flow sensors which work according to the calorimetric measurement principle are enhanced.

This object is achieved by the features described herein below.

The heater in accordance with the invention is based on the generic prior art, but in instead, the means for determining the temperature and/or the means which operate as overheating protection comprises a flowmeter which works according to the calorimetric measurement principle. This approach is based on the finding that a component which is ordinarily used as a calorimetric flow sensor can be used as a temperature sensor, both as a temperature sensor for protection against overheating and also as a temperature sensor for measuring the temperature. Here, it is especially possible to use only a single element for implementation of temperature detection and protection against overheating. This element preferably has a maximum of four and ideally two contacts; this will be explained in detailed. The total costs for the component which has been used in the past as protection against overheating can likewise be eliminated. Since it is then possible for the flow sensor which works according to the calorimetric measurement principle and which is used in accordance with the invention to evaluate the energy removal instead of a boundary temperature, critical states can be detected long before reaching the boundary temperature. Thus, the reaction rate of the system is greatly improved and the safety greatly enhanced. In particular, the initially mentioned problem of dry overheating is reliably managed by the approach in accordance with the invention, since the flow sensor recognizes the overly low energy removal long before the critical temperature is reached. In this way, the heater can withstand several dry overheatings without damage.

In the preferred embodiment of the heater in accordance with the invention, it is provided that the flow sensor is arranged such that it is surrounded, at least in sections, by a heat transfer medium. In conjunction with a motor vehicle heater, the heat transfer medium can be formed especially by cooling water which is heated by the heater in order to later, at least partially, release the absorbed heat at the desired location. In this case, the flow sensor is preferably located in the region of the heat exchanger of the heater. However, the heater in accordance with the invention can also be an air heater in which the air intended for heating a space is directly heated. In this case, the flow sensor is preferably located in the air flow. Alternatively, the flow sensor can also be accommodated in a solid medium since the use of a flow sensor in accordance with the invention works wherever there is an energy flow.

Furthermore, it is preferred that the flow sensor have a heating element and a temperature measurement means. The heating element can be especially a heating resistor and the temperature measurement means can be a temperature-dependent measurement resistor. The heating resistor and the measurement resistor can be triggered separately via a respective pair of lines so that the sensor element has four contacts in this case. Alternatively, it is possible to couple the heating resistor and the measurement resistor such that there is a center tap, the sensor in this case having three contacts.

However, in the especially preferred embodiment of the heater in accordance with the invention, it is provided that the heating element and the temperature measurement means are formed by a component or group of components which operate in alternation as a heating element and as a temperature measurement means. For example, a suitable resistance element can be used in alternation as a heating resistor and as a temperature-dependent measurement resistor, so that the sensor need have only two contacts; this makes the sensor especially economical. Even if the design with only one element is especially economical, in systems for which increased safety is required, it can be feasible to use at least one other redundant system in addition to the checking of short circuits, interruption, operation and plausibility which preferably takes place. Therefore, in this case, an embodiment with two resistance elements which are used as a heating means and a temperature measurement means is a good idea. It is assumed that the two resistors have temperature dependencies with characteristics which are known. Thus, it is possible in a steady state to deduce the ambient temperature by measuring the resistance value on one resistor, and from this ambient temperature to determine which resistance value the second resistor would have. If the deviation of this set point relative to the actual value is outside of the tolerable range, there is an error in the sensor which, on the software side, should lead to initiation of the corresponding measures. Such measures can include, for example, faulty interlocking of the vehicle heating system. It is advantageous if the rated values, and optionally, the characteristics of the two resistors differ so that changes of properties, i.e., especially parasitic resistances, drifting and material changes, act differently on the measured values with reference to the standard characteristics. The check can be repeated cyclically and as often as desired between the normal working cycles of the sensor, therefore, also during burner operation of the vehicle heating system.

It is preferred that defined energy supply can take place via the heating element and that energy removal can be deduced via subsequent cooling which has been detected by the temperature measurement means. In this connection, it is assumed that the energy-transporting coolant must be able to remove at least the same amount of energy as is delivered by the heating system. Here, it is quite irrelevant at which rate the heat transfer medium is flowing or how high its heat capacity is. What is important is solely the ascertained behavior of the cooling curve which constitutes a measure of the energy balance of the system and which, moreover, depending on the length of the cooling phase, can directly measure the temperature of the medium or can deduce it by extrapolation. The important difference from the initially mentioned gradient evaluation consists in that, in accordance with the invention, there is a defined electrical heating of the sensor which constitutes a defined energy supply, and consequently, allows defined energy removal to be deduced by the subsequent cooling. A critical energy balance (overly low energy removal) is an important criterion for protecting the system against overheating and can be recognized long before reaching a critical temperature and can be used as a threshold for initiating safety measures. In this case it is especially advantageous for the reaction speed of the sensor if the thermal inertia of the sensor is low.

Another aspect of this invention relates to use of a flow sensor which works according to the calorimetric measurement principle as a temperature sensor. These flow sensors are based on energy being removed from the sensor element which has been heated beyond the ambient temperature by the medium surrounding it. The sensor element is cooled more strongly, the more strongly the medium flows or the higher its thermal conductivity and its specific heat capacity. The cooling or heating curves of the sensor conventionally follow an asymptotic e-function. The use of such a flow sensor as a temperature sensor is, among other things, especially advantageous because, at any instant, there is the possibility of diagnosis of the feed lines for a short circuit or interruption. Correct operation of the component can be cyclically checked by heating the element and measuring the resistance beforehand and afterwards. A change of the resistance value is assumed for an intact sensor element. If the resistance does not change, a defect must be assumed. In contrast to conventional use of flow sensors which are operating according to the calorimetric measurement principle, in the use in accordance with the invention, no knowledge of the properties of the medium is necessary since preferably only adequate energy removal is detected.

Wherever cooling and/or heating play a part, an equalized energy balance of the system is the prerequisite for protection against critical states, and the use of a flow sensor operating according to the calorimetric measurement principle as a temperature sensor, i.e., as overheating protection, and/or as a sensor for determining the temperature, is possible. Here, use is not restricted to liquid media. This principle works wherever an energy flow is taking place, therefore, also in gaseous and solid media. For this purpose, movement of the medium is not even necessary (for example, when thermal conductivity is good enough to remove excess energy). An important innovation in sensor technology is heating of the measurement element which makes a system, with its own energy balance which can be evaluated, from the sensor. The sensor and the system to be protected should be suitably matched to one another.

It is considered especially advantageous that the flow sensor has the function of overheating protection. In conventional temperature sensors used as overheating protection, a degradation of thermal conductivity caused, for example, by calcification and/or deposit formation on the upper or contact surface leads to a shift of the operating threshold in the direction of higher temperatures so that the system is more strongly loaded. In contrast, a degradation of thermal conductivity, and thus, of energy removal caused by aging phenomena in the application of a flow sensor in accordance with the invention as a overheating protection leads to the gradient becoming flatter, i.e., the shift of the reaction point leads to a shift of the operating threshold in the direction of lower temperatures so that critical state are recognized earlier.

Furthermore, it can be provided in accordance with the invention that the flow sensor is designed for determination of the temperature. In this connection, it is considered especially advantageous if a single flow sensor is used both as overheating protection and also for temperature measurement since, in this case, instead of the two components which are conventionally used for this purpose, only one component is necessary. The temperature can be measured directly or determined via extrapolation.

It is preferred for the use in accordance with the invention that the flow sensor is a heating element and has a temperature measurement means. In this connection, to avoid repetition, reference is made to the corresponding statements in conjunction with the heater in accordance with the invention.

The same applies analogously to the case in which it is provided that the heating element and the temperature measurement means are formed by a component or a component group which is operated in alternation as a heating element and as a temperature measurement means.

Furthermore, in conjunction with the use in accordance with the invention, it is also preferred that defined energy supply take place via the heating element and energy removal be deduced via subsequent cooling which is detected via the temperature measurement means. In this respect, reference is made to the explanations in conjunction with the heater in accordance with the invention.

Furthermore, the invention relates to a process for determining the temperature and/or for making available overheating protection in a vehicle heater in which using a flow sensor which operates according to the calorimetric measurement principle the temperature of a heat transfer medium is measured at least two instants.

In this connection, it can be provided that, when the temperature is determined and/or overheating protection is provided, comparison of the time information and the temperature information with a conventional cooling function takes place. The cooling curve of the sensor body follows essentially an asymptotic e-function according to the relationship:

T=f(t)=a×e^{-bt}+c

in which

T is the temperature and t is the time;

a is the distance of the starting point from the asymptote (a+c), i.e., represents the starting temperature;

b is a measure for the combination of the material properties thermal conductivity and specific heat capacity and the flow velocity of the heat transfer medium, or a measure for energy removal; and

c indicates the location of the asymptote, i.e., the final temperature.

However, it can also be useful to compare time information and temperature information with known boundary values when the temperature is being determined and/or overheating protection is being provided. The only iteratively possible, and thus complex, determination of the coefficients a, b, and c of the cooling function can be bypassed in this way. The temperature increase during the heating phase is evaluated, the heating phase being defined by the time interval and the added heat energy. The boundary value function depending on the allowable temperature increase referenced to the ambient temperature should be filed as an equation or table, the specific structural application having to be considered in each case. Comparison of the determined temperature increase with the corresponding boundary value delivers the decision whether it is a critical state or not.

The invention is explained by way of example below with reference to the accompanying drawings.

### BRIEF DESCRIPTION OF THE DRAWINGS

FIG. 1 is a highly simplified schematic block diagram of a motor vehicle heater;

FIG. 2 is a graph which illustrates two typical cooling curves of a sensor body;

FIG. 3 shows a flow sensor which operates according to the calorimetric measurement principle with four contacts;

FIG. 4 shows a flow sensor which operates according to the calorimetric measurement principle with three contacts;

FIG. 5 shows a flow sensor which operates according to the calorimetric measurement principle with two contacts;

FIG. 6 shows the typical temperature behavior of a sensor element for alternating heating and cooling phases.

### DETAILED DESCRIPTION OF THE INVENTION

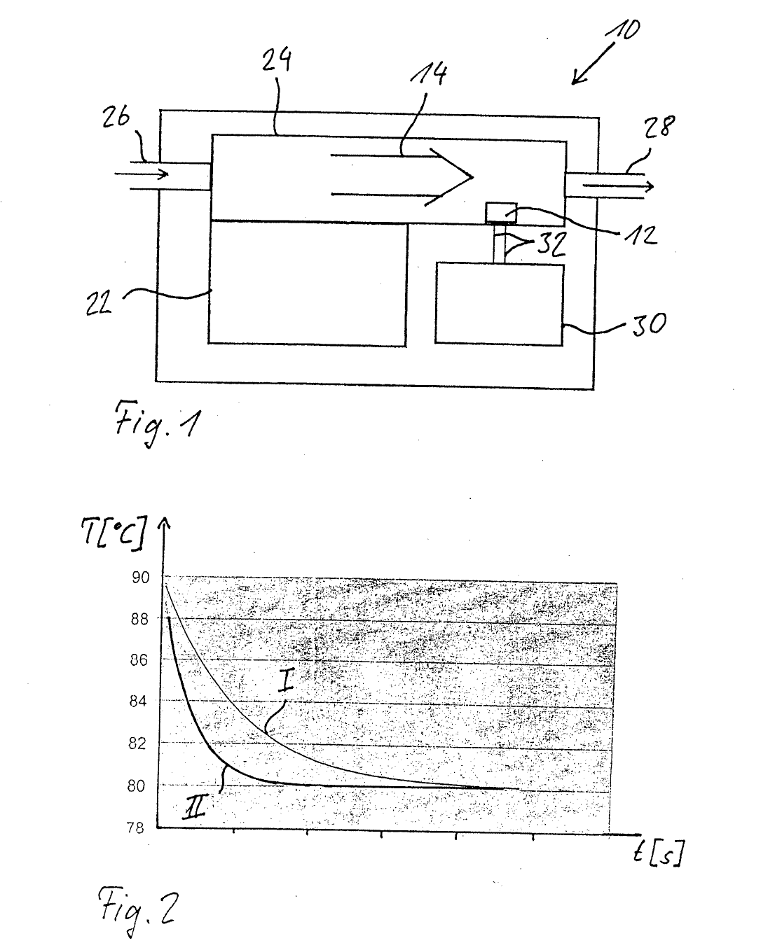

The motor vehicle heater 10, shown only schematically in FIG. 1, can be especially an auxiliary and/or independent vehicle heater. The heater 10 has a burner 22 by which a heat transfer medium 14 which flows through a heat exchanger 24 can be heated. Here, the heat exchanger 24 has a inlet 26 and a outlet 28. A control device 30 controls all operation of the heater 10.

According to the prior art, in heaters of this type, conventionally, there are at least two temperature sensors. Protection against overheating, for example, in the form of a PTC, a bimetallic switch or a fuse-link, and a temperature-dependent resistor (NTC) for determining the actual temperature.

Instead of these two temperature sensors, as shown in FIG. 1, there is a single flow sensor 12 which works according to the calorimetric measurement principle and which is used both for overheating protection and also for actual temperature measurement. Although fundamentally other solutions are also possible, the flow sensor 12 is connected to the control 30 via simply two connecting lines 32.

These flow sensors are used originally, for known properties of the medium, such as thermal conductivity and specific heat capacity, to detect the flow velocity of the medium, or vice versa, at the known flow velocity, to deduce the current material properties. The sensor element is heated for this purpose beyond the ambient temperature by means of a heating resistor. The curve behavior which results from measurements taken during the subsequent cooling phase is evaluated to deduce the flow velocity or the material properties. The use of a flow sensor in the conventional sense, therefore, presupposes either knowledge of the properties of the medium or the velocity of the medium. For example, in heaters, they cannot be assumed to be given due to the frost and corrosion prevention additives which are proportioned different in practice or the different pump outputs and flow resistances.

Therefore, it is assumed in accordance with the invention that the energy transporting heat transfer medium 14 must be able to remove at least the same amount of energy as is delivered by the heating system. Here, it is quite irrelevant at which velocity the medium 14 is flowing or how high its heat capacity is. What is important is solely the ascertained curve behavior which constitutes a measure of the energy balance of the system and which, moreover, depending on the length of the cooling phase, can directly measure the temperature of the medium or can deduce it by extrapolation. As mentioned, the important difference from the conventional gradient evaluation lies in that there is defined electrical heating of the sensor which constitutes a defined energy supply, and consequently, allows defined energy removal to be deduced by the subsequent cooling.

FIG. 2 shows two typical cooling curves of the sensor body of the flow sensor 12, the temperature in degrees Celcius being plotted over time in seconds. The two illustrated curves follow essentially an asymptotic e-function with:

T=f(t)=a×e^{-bt}+c

in which

a is the distance of the starting point from the asymptote (a+c), i.e., represents the starting temperature;

b is a measure for the combination of the material properties thermal conductivity and specific heat capacity and the flow velocity of the heat transfer medium, or a measure of energy removal; and

c indicates the location of the asymptote, i.e., the final temperature.

For the curves I and II shown in FIG. 2, a=10K, c=80° C. and b=0.5 (curve 1) and b=1.3 (curve 2). FIG. 2 shows that the quantity b as a measure of energy removal greatly influences the behavior of the decay curve.

FIG. 3 shows one embodiment of a flow sensor 12 in which there are a separately triggered heating element 16 in the form of a heating resistor and a separately triggered temperature measurement means 18 in the form of a temperature-dependent measurement resistor. The heating element 16 and the temperature measurement means 18 are operated in alternation and four contacts are necessary. The concept “in alternation” in this and comparable connections means that during certain time intervals heating takes place, and for other time intervals, a measurement function is performed; measurement directly following heating or heating directly following measurement are thus not necessary.

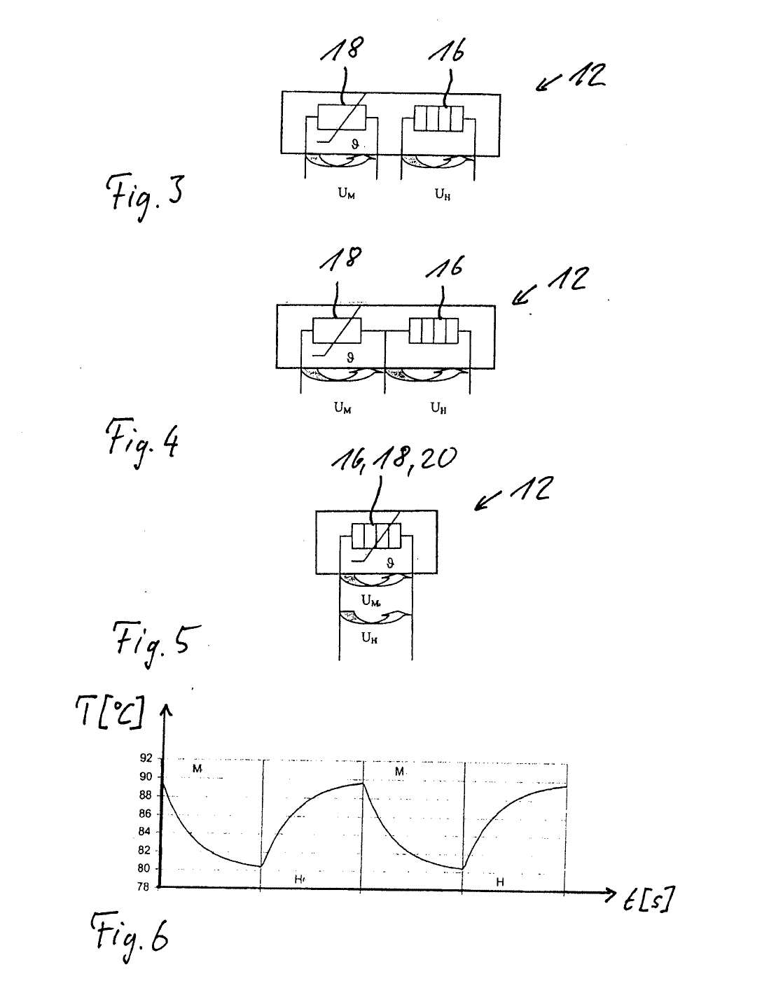

FIG. 4 shows one embodiment of a flow sensor 12 in which a heating element 16 in the form of a heating resistor and a temperature measurement means 18 in the form of a temperature-dependent measurement resistor are connected in series, there being a middle tap. The heating element 16 and the temperature measurement means 18 are operated in alternation and three contacts are necessary.

FIG. 5 shows one especially preferred embodiment of a flow sensor 12 in which a heating element 16 and a temperature measurement means 18 are formed by a jointly used component 20 which, in this case, is in the form of a suitable resistance element. The resistance element 20 is used in alternation as a heating resistor and as a temperature-dependent measurement resistor so that only two contacts are necessary.

In FIGS. 3 to 5, the measurement voltage is labeled UM and the heating voltage is labeled U_{H}.

FIG. 6 shows the typical behavior of the sensor body temperature (for example, for the temperature sensor 12 as shown in FIG. 5) which arises when heating and temperature determination take place in alternation. Here, the temperature in ° C. is plotted over time in seconds and the measurement phases are labeled M while the heating phases are labeled H.

The features of the invention disclosed in the description above, in the drawings and in the claims can be important both individually and also in any combination for implementation of the invention.

What is claimed is:

1-14. (canceled)

15. Heater, comprising at least one of a means for determining temperature and means for protecting against overheating of the heater, the at least one of the means for determining temperature and the means for protecting against overheating of the heater comprises a calorimetric measurement flow sensor.

16. Heater as claimed in claim 15, wherein the flow sensor is arranged with at least sections thereof surrounded by a heat transfer medium.

17. Heater as claimed in claim 15, wherein the flow sensor has a heating element and a temperature measurement means.

18. Heater as claimed in claim 17, wherein the heating element and the temperature measurement means are formed by at least one component which is operable in alternation as the heating element and as the temperature measurement means.

19. Heater as claimed in claim 17, wherein the heating element provides a defined energy supply and wherein energy removal is deduced via subsequent cooling of the heating element which is detected by the temperature measurement means.

20. Use of a flow sensor which works according to the calorimetric measurement principle as a temperature sensor.

21. Use of a flow sensor which works according to the calorimetric measurement principle, as claimed in claim 20, to provide overheating protection.

22. Use of a flow sensor which works according to the calorimetric measurement principle, as claimed in claim 20, wherein the flow sensor determines temperature.

23. Use of a flow sensor which works according to the calorimetric measurement principle as claimed in claim 20, wherein the flow sensor has a heating element and a temperature measurement means.

24. Use of a flow sensor which works according to the calorimetric measurement principle as claimed in claim 23, wherein the heating element and a temperature measurement means are formed by at least one component which is operated in alternation as a heating element and as a temperature measurement means.

25. Use of a flow sensor which works according to the calorimetric measurement principle as claimed in claim 23, wherein defined energy supply takes place via the heating element and energy removal is deduced via subsequent cooling which has been detected by the temperature measurement means.

26. Process at least one of determining the temperature and for providing overheating protection in a motor vehicle heater, wherein using a flow sensor which works according to the calorimetric measurement principle the temperature of a heat transfer medium is measured at least two instants.

27. Process as claimed in claim 26, wherein when at least one of the temperature is determined and/or overheating protection is provided by comparison of time information and temperature information with a known cooling function takes place.

28. Process as claimed in claim 27, wherein when said at least one of the temperature is determined and/or overheating protection is made providing comparison of the time information and the temperature information with known boundary values takes place by comparison of time information and temperature information with a known cooling function takes place
